(19) United States
(12) Patent Application Publication
(10) Pub. No.: US 2010/0326079 A1
(43) Pub. Date: Dec. 30, 2010

(54) METHOD AND SYSTEM TO REDUCE VANE SWIRL ANGLE IN A GAS TURBINE ENGINE

(76) Inventors: Baifang Zuo, Simpsonville, SC (US); Willy Steve Ziminsky, Simpsonville, SC (US); Benjamin Paul Lacy, Greer, SC (US); David Kenton Felling, Greenville, SC (US)

Correspondence Address: JOHN S. BEULICK (17851);ARMSTRONG TEASDALE LLP, 7700 Forsyth Boulevard, Suite 1800, St. Louis, MO, 63105, US

(21) Appl. No.: 12/491,393

(22) Filed: Jun. 25, 2009

(51) Int. Cl. F02C 7/22

(52) U.S. Cl. 60/748

(57) ABSTRACT

A fuel nozzle assembly includes a swirler assembly having an inlet end, an outlet end, a shroud inner surface and a hub outer surface. The inner surface has a first diameter adjacent to the inlet end and a second diameter adjacent to the outlet end defining a differential diameter ratio. A plurality of vanes are coupled to the swirler assembly and extend between the shroud inner surface and the hub outer surface. The vanes have a pair of opposing sidewalls joined at a leading edge and at an axially-spaced trailing edge, and a first height adjacent to the leading edge and a second height adjacent to the trailing edge. The first height and the second height define a differential height ratio, wherein the differential diameter ratio, the differential height ratio, or both are configured to provide convergent flow through the fuel nozzle.

### STATEMENT REGARDING FEDERALLY SPONSORED RESEARCH & DEVELOPMENT

This invention was made with Government support under DE-FC26-05NT42643 awarded by the Department of Energy (“DOE”). The Government has certain rights in this invention.

### BACKGROUND OF THE INVENTION

This invention relates generally to gas turbine engines and more particularly to methods and systems to reduce vane swirl angle in a combustor.

At least some gas turbine engines ignite a fuel-air mixture in a combustor to generate a combustion gas stream that is channeled to a turbine. Compressed air is channeled to the combustor from a compressor. Combustor assemblies typically have one or more fuel nozzles that facilitate fuel and air delivery to a combustion region of the combustor. At least some known fuel nozzles include a swirler assembly that includes a plurality of vanes coupled thereto. During assembly, a cover or shroud is coupled to the fuel nozzle assembly such that the cover substantially circumscribes the vanes. As such, an interior surface of the cover and an exterior surface of the swirler assembly define a flowpath for channeling airflow through the fuel nozzle.

During operation, fuel is typically channeled through a plurality of passages formed within the swirler assembly and through a plurality of openings defined in at least one side of each respective vane. Known vanes are formed with an airfoil-shaped profile that induces a swirl to fuel and/or air flowing past the vane. Moreover, in at least some known swirler assemblies, the vanes induce a swirl angle between 0 and 60 degrees to stabilize a gas flame and to prevent flame flashback near nozzle exit. The swirl angle is usually partially based upon the vane thickness and/or vane shape. For some types of fuels, such as syngas and high-hydrogen fuels, it may be beneficial to reduce the vane swirl angle to obtain optimum flame characteristic. However, for many swirler assemblies a minimum workable swirl angle exists, and using a swirl angle below such a minimum may result in less than optimum flow (e.g., diverging cascade flow) thru the nozzle.

Moreover, in known swirler assembly designs, optimizing the swirl angle may be difficult for swirler assemblies used with highly reactive fuels. To optimize the swirler angle, at least some known swirler assemblies have modified the location, airfoil shape, and size of the swirler vanes to induce de-swirling of the flow through the swirler assembly. However, modifying known swirler assemblies may induce flow separation and/or adverse flame holding due to divergent cascade flow. While these known methods and systems have provided some useful improvements in fuel nozzle performance, there still exists a desire to improve fuel nozzle performance and enhance flame holding characteristics.

### BRIEF DESCRIPTION OF THE INVENTION

In one aspect, a method for assembling a fuel nozzle for use in a gas turbine engine is provided. The method includes providing a swirler assembly having an inlet end, an outlet end, and a shroud inner surface and a hub outer surface. The shroud inner surface has a first diameter adjacent the inlet end and a second diameter adjacent the outlet end, and the first diameter and the second diameter define a differential diameter ratio. The method further includes coupling a plurality of vanes to the swirler assembly, each vane extending between the shroud inner surface and the hub outer surface. Each vane has a pair of opposing sidewalls joined at a leading edge and at a trailing edge, and each vane has a first height adjacent to the leading edge and a second height adjacent to the trailing edge. The first height and the second height define a differential height ratio, wherein the differential diameter ratio, the differential height ratio, or both are configured to provide convergent flow through the fuel nozzle.

In another aspect, a fuel nozzle assembly is provided that includes a swirler assembly having an inlet end, an outlet end, a shroud inner surface and a hub outer surface. The inner surface has a first diameter adjacent to the inlet end and a second diameter adjacent to the outlet end, and the first diameter and the second diameter define a differential diameter ratio. The fuel nozzle assembly also has a plurality of vanes coupled to the swirler assembly and extending between the shroud inner surface and the hub outer surface. Each of the vanes has a pair of opposing sidewalls joined at a leading edge and at an axially-spaced trailing edge, and each of the vanes also has a first height adjacent to the leading edge and a second height adjacent to the trailing edge. The first height and the second height define a differential height ratio, wherein the differential diameter ratio, the differential height ratio, or both are configured to provide convergent flow through the fuel nozzle.

In a further aspect, a gas turbine engine having a compressor and a combustor is provided. The combustor is in flow communication with the compressor, and has at least one fuel nozzle assembly. The fuel nozzle assembly includes a swirler assembly having an inlet end, an outlet end, a shroud inner surface and a hub outer surface. The inner surface has a first diameter adjacent to the inlet end and a second diameter adjacent to the outlet end, wherein said first diameter and said second diameter define a differential diameter ratio. The fuel nozzle assembly further includes a plurality of vanes coupled to the swirler assembly and extending between the shroud inner surface and the hub outer surface, wherein each of the vanes has a pair of opposing sidewalls joined at a leading edge and at an axially-spaced trailing edge. Each of the vanes also has a first height adjacent to the leading edge and a second height adjacent to the trailing edge. The first height and the second height define a differential height ratio, wherein the differential diameter ratio, the differential height ratio, or both are configured to provide convergent flow through the fuel nozzle.

### BRIEF DESCRIPTION OF THE DRAWINGS

FIG. 1 is a schematic view of an exemplary gas turbine engine;

FIG. 2 is a cross-sectional schematic view of an exemplary combustor used with the gas turbine engine shown in FIG. 1;

FIG. 3 is a cross-sectional schematic view of an exemplary fuel nozzle assembly used with the combustor shown in FIG. 2;

FIG. 4 is a cross-sectional view of a swirler assembly used with the fuel nozzle assembly shown in FIG. 3; and

FIG. 5 is a plan view of a portion of an exemplary swirler vane used with the swirler assembly shown in FIG. 4.

### DETAILED DESCRIPTION OF THE INVENTION

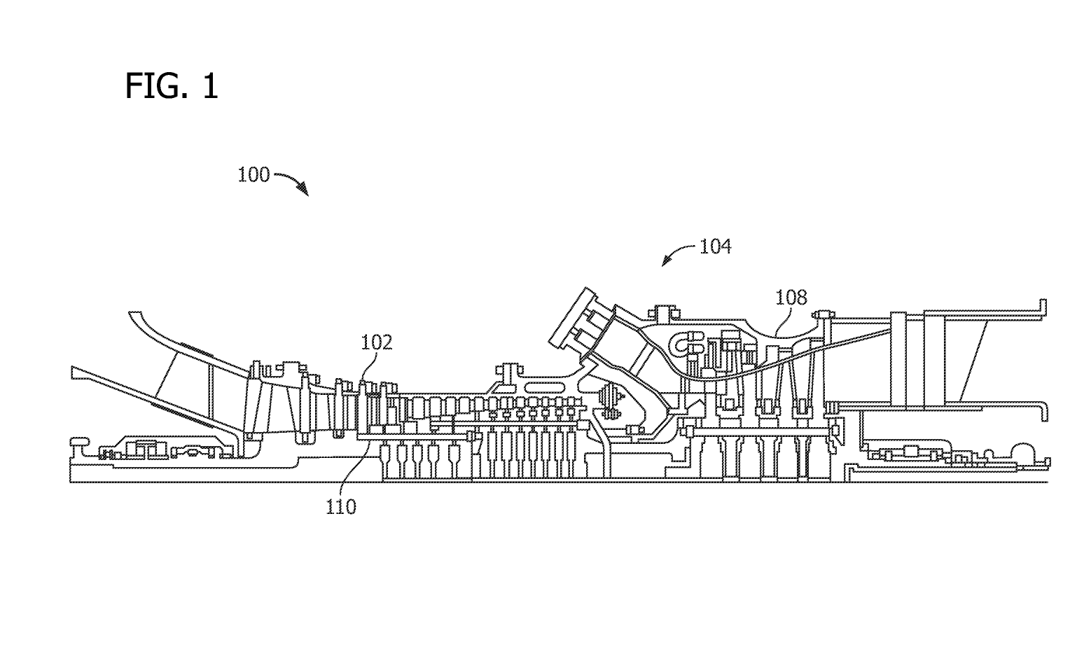

FIG. 1 is a schematic illustration of an exemplary gas turbine engine 100. Engine 100 includes a compressor 102 and a plurality of combustors 104. Engine 100 also includes a turbine 108 and a common compressor/turbine shaft 110 (sometimes referred to as a rotor 110).

In operation, air flows through compressor 102 such that compressed air is supplied to combustor assembly 104. Fuel is channeled to a combustion region, within combustor assembly 104 wherein the fuel is mixed with the air and ignited. Combustion gases are generated and channeled to turbine 108 wherein gas stream thermal energy is converted to mechanical rotational energy. Turbine 108 is rotatably coupled to, and drives, shaft 110.

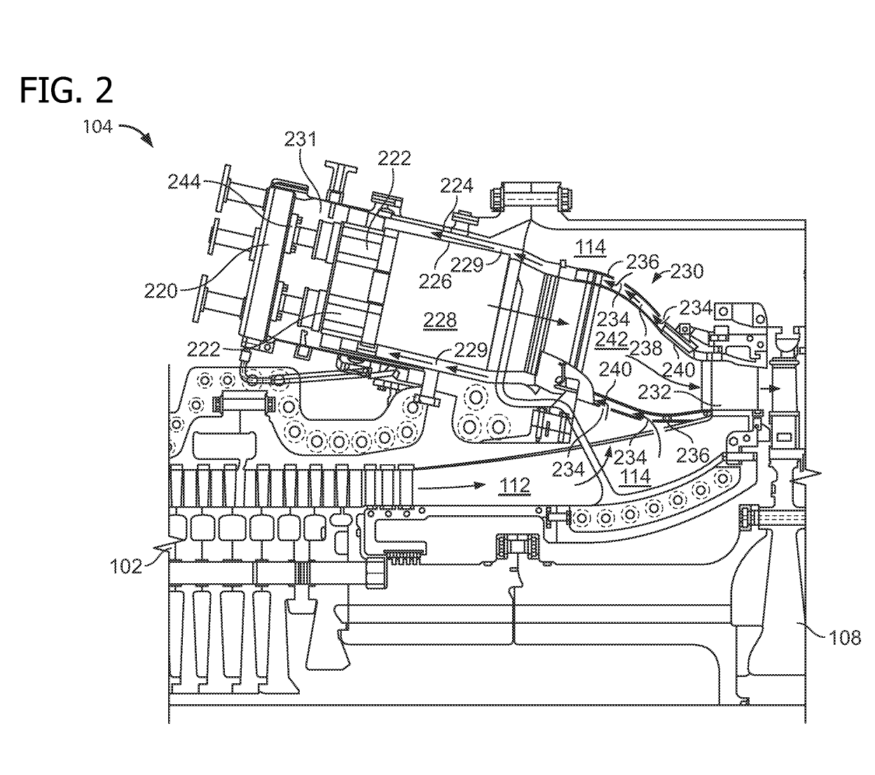

FIG. 2 is a cross-sectional schematic view of a combustor assembly 104. Combustor assembly 104 is coupled in flow communication with turbine assembly 108 and with compressor assembly 102. In the exemplary embodiment, compressor assembly 102 includes a diffuser 112 and a compressor discharge plenum 114 that are coupled in flow communication to each other.

In the exemplary embodiment, combustor assembly 104 includes an end cover 220 that provides structural support to a plurality of fuel nozzles used with combustor assembly 104. In the exemplary embodiment, fuel nozzle assembly 222 is coupled to end cover 220 via a fuel nozzle flange 244. End cover 220 is coupled to combustor casing 224 with retention hardware (not shown in FIG. 2). A combustor liner 226 is positioned within combustor assembly 104 such that liner 226 is coupled to casing 224 and such that liner 226 defines a combustion chamber 228. An annular combustion chamber cooling passage 229 is defined between combustor casing 224 and combustor liner 226.

A transition piece 230 is coupled to combustor chamber 228 to channel combustion gases generated in chamber 228 towards turbine nozzle 232. In the exemplary embodiment, transition piece 230 includes a plurality of openings 234 defined in an outer wall 236. Transition piece 230 also includes an annular passage 238 defined between an inner wall 240 and outer wall 236. Inner wall 240 defines a guide cavity 242.

During operation, turbine assembly 108 drives compressor assembly 102 via shaft 110 (shown in FIG. 1). As compressor assembly 102 rotates, compressed air is channeled through diffuser 112 as illustrated by arrows in FIG. 2. In the exemplary embodiment, the majority of air discharged from compressor assembly 102 is channeled through compressor discharge plenum 114 towards combustor assembly 104, and the remaining compressed air is channeled downstream for use in cooling engine components. More specifically, the pressurized compressed air within plenum 114 is channeled into transition piece 230 via outer wall openings 234 and into passage 238. Air is then channeled from transition piece annular passage 238 into combustion chamber cooling passage 229, prior to being channeled into fuel nozzles 222.

Fuel and air are mixed and ignited within combustion chamber 228. Casing 224 facilitates isolating combustion chamber 228 and its associated combustion processes from the surrounding environment, for example, surrounding turbine components. Combustion gases generated are channeled from chamber 228 through transition piece guide cavity 242 towards turbine nozzle 232.

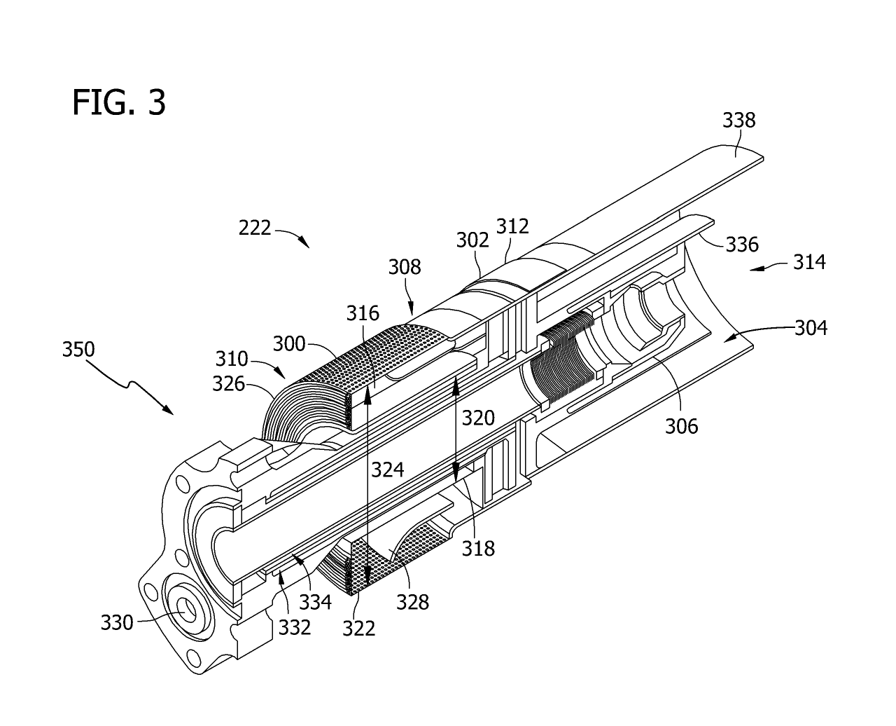

FIG. 3 is a cross-sectional view of fuel nozzle assembly 222. Fuel nozzle assembly 222 is divided into four regions including an inlet flow conditioner (IFC) 300, a swirler assembly 302, an annular fuel fluid mixing passage 304, and a central diffusion flame fuel nozzle assembly 306. Fuel nozzle assembly 222 also includes a high pressure plenum 308 that includes an inlet end 310 and a discharge end 312. High pressure plenum 308 circumscribes nozzle assembly 222, and discharge end 312 does not circumscribe nozzle assembly 222. Rather, discharge end 312 extends into a combustor reaction zone 314. IFC 300 includes an annular flow passage 316 that is defined by cylindrical walls 318 and 322. Wall 318 defines an inner diameter 320 for passage 316, and a perforated cylindrical outer wall 322 defines an outer diameter 324. A perforated end cap 326 is coupled to an upstream end 350 of fuel nozzle assembly 222. In the exemplary embodiment, flow passage 316 includes at least one annular guide vane 328. More specifically, in the exemplary embodiment, compressed fluid enters IFC 300 via perforations formed in end cap 326 and cylindrical outer wall 322. Moreover, it should be understood that in the exemplary embodiment, nozzle assembly 222 defines a premix gas fuel circuit that enables combustible fuel and compressed fluid to be mixed together prior to combustion.

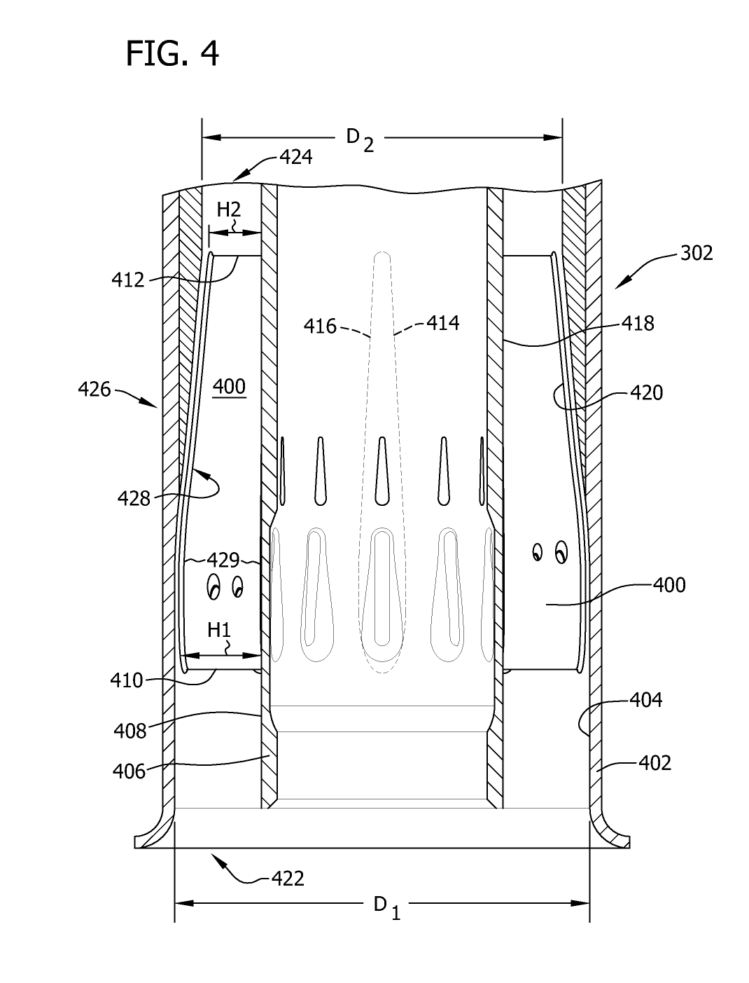

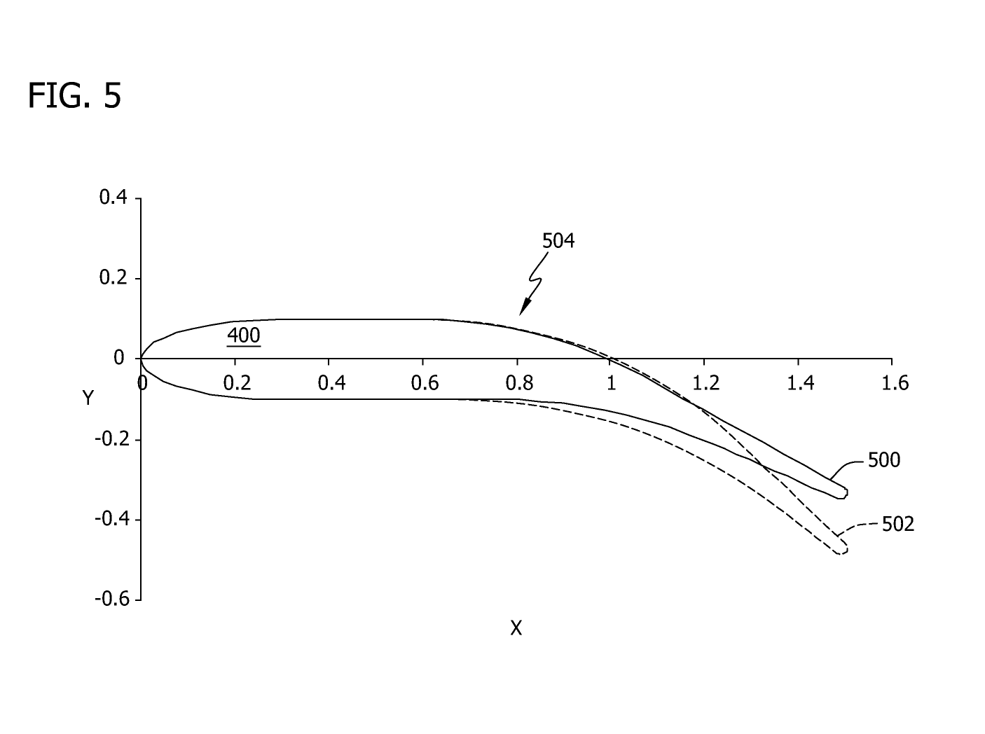

Referring now to FIGS. 4 and 5, FIG. 4 is a cross-sectional view of a swirler assembly 302 and FIG. 5 is a plan view of a portion of an exemplary swirler vane 400 used with swirler assembly 302. In the exemplary embodiment, swirler assembly 302 includes a plurality of swirler vanes 400 that each extend between a radial outer shroud 402, having an inner surface 404, and a radial inner hub 406, having an outer surface 408. Each vane 400 includes a leading edge 410, an axially-spaced trailing edge 412, and a pair of opposing sidewalls 414 and 416 that are joined at leading edge 410 and at trailing edge 412. Sidewalls 414 and 416 extend between inner hub 406 and outer shroud 402. A vane root 418 is defined adjacent to inner hub 406, and a vane tip 420 is defined adjacent an inner surface 404 of outer shroud 402.

In the exemplary embodiment, outer shroud 402 is formed with an inner surface 404 that includes two diameters D₁ and D₂ that are measured at an inlet 422 and an outlet 424 of swirler assembly 302. Correspondingly, vane 400 has two heights H₁ and H₂ that are measured at diameters D₁ and D₂ such that vane tip 420 substantially follows the contour of outer shroud inner surface 404. A shroud transition region 426 extends along inner surface 404 between diameters D₁ and D₂. Shroud transition region 426 is positioned vane tip 420. A vane transition region 428 is defined in vane tip 420 and forms a transition between vane heights H₁ and H₂. In the exemplary embodiment, transition points 426 and 428 are adjacent to a maximum chord dimension 429 of vane 400. In other embodiments, transition points 426 and 428 are located within an upstream half of vane 400 as measured from leading edge 410 to trailing edge 412. It should be understood that a location of transition points 426 and 428 may be variably selected based on requirements of swirler assembly 302. Moreover, one of ordinary skill in the art would understand that the flow characteristics can be optimized by selecting various positions for transition points 426 and 428 and that flow characteristics can be optimized by selecting various diameters D₁ and D₂, as well as vane heights H₁ and H₂.

In an alternate embodiment, outer shroud inner surface 404 may include a plurality of different diameters between diameters D1 and D2 such that a curved or streamlined transition is defined between diameters D1 and D2. Correspondingly, an alternate embodiment may include a vane tip 420 that includes a plurality of heights defined between heights H1 and H2 such that a curved or streamlined transition is defined between heights H1 and H2. In alternate embodiments, there may be a plurality of transition regions/points 426 and 428 used to define outer shroud inner surface 404. Moreover, one of ordinary skill in the art would understand that providing a streamlined transition between inlet diameter D1 and outlet diameter D2 can facilitate optimizing various flow characteristics through swirler assembly 302.

In the exemplary embodiment, vane 400 is formed to include two swirl angles 500 and 502 from a single airfoil profile 504. Airfoil profile 504 may be used with swirler assembly 302. A first swirler angle 500 is approximately a 30° swirl angle and a second swirl angle 502 is approximately a 45° degree swirl angle. Vane 400 is coupled with swirler assembly 302 (shown in FIG. 4) to enable a reduction in vane swirl angle from 502 to 500 without altering the airfoil profile of vane 400.

By shaping outer shroud 402 with a diameter that reduces from D1 to D2, a continuously accelerating cascade flow is facilitated at very low swirl angles. In one embodiment, the reduction in diameter D2 in the outer shroud 402 can be used with a vane 400 having an approximately zero degree swirl angle. The use of very low swirl angles facilitates and optimizes the use of alternative fuels, such as syngas and high hydrogen fuel. Reducing the outer shroud diameter from D1 to D2 facilitates the production of a converging cascade flow.

The invention described herein provides several advantages not found in known swirler assembly configurations. For example, one advantage of the swirler assembly described herein is that flame holding is optimized and thus provides improved flame holding characteristics. Another advantage is that the swirl angle can be substantially reduced while maintaining converging cascade flow within the fuel nozzle. Still another advantage is that the swirl angle can be substantially reduced while using the same vane airfoil profile. Finally, gas turbine flexibility is increased because other fuel sources such as syngas and high hydrogen fuel may be used because the invention increases the high reactive fuel flame holding margins by using reduced swirl angles.

Exemplary embodiments of a method and system to reduce vane swirl angle in a gas turbine engine is described above in detail. The method and system are not limited to the specific embodiments described herein, but rather, components of systems and/or steps of the methods may be utilized independently and separately from other components and/or steps described herein. For example, the method may also be used in combination with other fuel systems and methods, and are not limited to practice with only the fuel systems and methods as described herein. Rather, the exemplary embodiment can be implemented and utilized in connection with many other gas turbine engine applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described in terms of various specific embodiments, those skilled in the art will recognize that the invention can be practiced with modification within the spirit and scope of the claims.

1. A method for assembling a fuel nozzle for use in a gas turbine engine, said method comprising:
providing a swirler assembly including an inlet end, an outlet end, a shroud inner surface and a hub outer surface, wherein the inner surface has a first diameter at the inlet end and a second diameter at the outlet end; and
coupling a plurality of vanes to the swirler assembly, each vane extending between the shroud inner surface and the hub outer surface, each vane comprising a pair of opposing sidewalls joined at a leading edge and at a trailing edge, each vane having a first height adjacent to the leading edge and a second height adjacent to the trailing edge, the first height and the second height define a differential height ratio, wherein at least one of the differential diameter ratio and the differential height ratio are configured to provide convergent flow through the fuel nozzle.

2. A method in accordance with claim 1, wherein said providing the swirler assembly further comprises providing at least one shroud transition region defined between the first diameter and the second diameter.

3. A method in accordance with claim 1, wherein said coupling a plurality of vanes to the swirler assembly further comprises providing at least one vane transition region defined between the first height and the second height.

4. A method in accordance with claim 1, wherein said coupling a plurality of vanes to the swirler assembly further comprises providing at least one vane transition region defined between the first height and the second height, wherein the at least one vane transition region is substantially aligned with the at least one shroud transition region.

5. A method in accordance with claim 1, wherein said providing the swirler assembly further comprises providing at least one shroud transition region defined between the first diameter and the second diameter and positioned within a first half of a length of each vane as measured from the leading edge to the trailing edge.

6. A method in accordance with claim 1, further comprising configuring the differential diameter ratio and the differential height ratio to facilitate accelerating a convergent cascade flow within the fuel nozzle.

7. A fuel nozzle use in a gas turbine engine, said fuel nozzle comprising:
a swirler assembly comprising an inlet end, an outlet end, a shroud inner surface and a hub outer surface, said inner surface defining a first diameter at said inlet end and a second diameter at said outlet end; and
a plurality of vanes coupled to said swirler assembly and extending between said shroud inner surface and said hub outer surface, each said vane comprising a pair of opposing sidewalls joined at a leading edge and at an axially-spaced trailing edge, each said vane having a first height adjacent to said leading edge and a second height adjacent to said trailing edge, said first height and said second height define a differential height ratio, wherein at least one of said differential diameter ratio and said differential height ratio are configured to provide convergent flow through said fuel nozzle.

8. A fuel nozzle in accordance with claim 7, wherein said first diameter is larger than said second diameter.

9. A fuel nozzle in accordance with claim 7, wherein said inner surface further comprises at least one shroud transition region defined between said first diameter and said second diameter.

10. A fuel nozzle in accordance with claim 7, wherein said plurality of vanes further comprises at least one vane transition region defined between said first height and said second height.

11. A fuel nozzle in accordance with claim 9, wherein said plurality of vanes further comprises at least one vane transition region defined between said first height and said second height, wherein said at least one vane transition region is substantially aligned with said at least one shroud transition region.

12. A fuel nozzle in accordance with claim 9 wherein said at least one shroud transition region is positioned within a first half of a length of each said vane as measured from said leading edge to said trailing edge.

13. A fuel nozzle in accordance with claim 9, wherein said at least one shroud transition region is positioned adjacent to a maximum chord dimension of each said vane.

14. A fuel nozzle in accordance with claim 7, wherein said each vane further comprises a swirl angle between 0 and 60 degrees.

15. A fuel nozzle in accordance with claim 7, wherein said differential diameter ratio and said differential height ratio are configured to facilitate accelerating a convergent cascade flow within said fuel nozzle.

16. A gas turbine engine assembly comprising:
a compressor; and
a combustor in flow communication with said compressor, said combustor comprising at least one fuel nozzle assembly, said fuel nozzle assembly comprising:
a swirler assembly comprising an inlet end, an outlet end, a shroud inner surface and a hub outer surface, said inner surface having a first diameter adjacent to said inlet end and a second diameter adjacent to said outlet end, wherein said first diameter and said second diameter define a differential diameter ratio; and
a plurality of vanes coupled to said swirler assembly and extending between said shroud inner surface and said hub outer surface, each said vane comprising a pair of opposing sidewalls joined at a leading edge and at an axially-spaced trailing edge, each said vane having a first height adjacent to said leading edge and a second height adjacent to said trailing edge, said first height and said second height define a differential height ratio, wherein at least one of said differential diameter ratio and said differential height ratio are configured to provide convergent flow through said fuel nozzle.

17. A gas turbine engine assembly in accordance with claim 16, wherein said inner surface further comprises at least one shroud transition region defined between said first diameter and said second diameter.

18. A gas turbine engine assembly in accordance with claim 17, wherein said plurality of vanes further comprises at least one vane transition region defined between said first height and said second height, wherein said at least one vane transition region is substantially aligned with said at least one shroud transition region.

19. A gas turbine engine assembly in accordance with claim 17, wherein said at least one shroud transition region is positioned within a first half of a length of each said vane as measured from said leading edge to said trailing edge.

20. A gas turbine engine assembly in accordance with claim 16, wherein said differential diameter ratio and said differential height ratio are configured to facilitate accelerating a convergent cascade flow within said fuel nozzle.
